(19) United States
(12) Patent Application Publication
(10) Pub. No.: US 2010/0106490 A1
(43) Pub. Date: Apr. 29, 2010

(54) Method and Speech Encoder with Length Adjustment of DTX Hangover Period

(76) Inventors: Jonas Svedberg, Lulea (SE); Martin Sehlstedt, Lulea (SE)

Correspondence Address: ERICSSON INC., 6300 LEGACY DRIVE, M/S EVR 1-C-11, PLANO, TX, 75024, US

(21) Appl. No.: 12/593,712

(22) PCT Filed: Dec. 5, 2007
(86) PCT No.: PCT/SE07/01086

§ 371 Date: Sep. 29, 2009

Related U.S. Application Data
(60) Provisional application No. 60/907,347, filed on Mar. 29, 2007.

(51) Int. Cl. G10L 19/00

(52) U.S. Cl. 704/215; 704/E19.001

(57) ABSTRACT

The present invention relates to a speech encoder comprising: a voice activity detector (VAD) configured to receive speech frames and to generate a speech decision (VAD_flag), a speech/SID encoder configured to receive said speech frames and to generate a signal identifying speech frames based on the encoder decision (SP), which in turn is based on the speech decision (VAD_flag) and a DTX-hangover period, and a SID-synchronizer configured to transmit a signal (TxType) comprising speech frames, SID frames and No_data frames. The speech encoder further comprises: a signal analyzer configured to analyze energy values of speech frames within the DTX-hangover period, and a DTX-handler configured to adjust the length of the DTX-hangover period in response to the analysis performed by the signal analyzer. The invention also relates to a method for estimating the characteristic of a DTX-hangover period in a speech encoder.

### TECHNICAL FIELD

The present invention relates to a method for adapting the DTX hangover period in a telecommunication system.

### BACKGROUND

In a speech codec system with comfort noise generation there is a time period for estimation of the Comfort Noise Characteristics. The time period may be used by the encoder (forward adaptive) or by the decoder (backward adaptive) or both encoder/decoder (forward and backward adaptive) to determine the parameters used for comfort noise synthesis. I.e. the time period may be used by the encoder to estimate the noise character, which the will be quantized and transmitted to the decoder, or the decoder may use the time period for a receiver estimation of the noise which may be used in synthesis, or both methods may be used simultaneously.

In speech codec systems, such as GSM-EFR (Enhanced Full Rate) and AMR-NB (Narrow band) described in reference [1]; and AMR-WB (Wide band) described in reference [2], this time period for estimation is called the DTX-hangover period. If this time period contains stable and stationary noise the resulting comfort noise will have high subjective quality and if the time period contains other signals than noise there is a risk that the comfort noise will have an annoying sound.

Further, in some speech codec systems, such as for EFR and AMR, the addition of DTX-hangover period is controlled by a “dtx-handler” frame type state machine that allows the encoder and decoder to perform synchronized use of the information in the DTX-hangover period. This synchronization is especially important for EFR, since EFR actually uses the DTX-hangover period to quantize reference parameters for the following noise period. This encoder/decoder synchronization is explained in 3GPP/TS26.093 (reference [1]), and in U.S. Pat. No. 5,835,889 by Kapanen (reference [5]), with the title “Method and apparatus for detecting hangover periods in a TDMA wireless communication system using discontinuous transmission”. FIG. 1 shows the main functional building blocks for the encoder side of a prior art VAD/DTX/Codec system and FIG. 2 shows a normal DTX Hangover procedure from reference [1].

Note; often “noise period” is called “silence period” but in this document the term “noise period” will be used.

Existing (deployed) EFR and AMR decoders simply perform an average operation for the spectrum parameters and the energy parameters. If there is a high energy outlier or a spectral outlier in the DTX-hangover period there might arise an annoying noise energy wave or noise burst in the synthesized noise. This noise wave/burst may affect the Comfort noise negatively until the improper parameters from DTX-hangover time have been ‘forgotten’, (for AMR this is typically 11 frames or 220 ms).

One solution to this would be to add suppression of outliers in the decoder Comfort noise parameter analysis. This is for example done in the IS-641 DTX system, as described in TIA/EIS/IS-641 and in EP 0843301 B1, by Järvinen (reference [6]), with the title “Methods for generating comfort noise during discontinuous transmission”).

Also in U.S. Pat. No. 5,978,761, by Johansson (reference [8]) a receiver based method of removing outliers to improve comfort noise quality is described. Johansson describes how one can exclude some SID frames from being included in Comfort Noise Generation based on frame type transition analysis. This solution does however require updates of all receivers/decoders.

Another solution is to use a quite (or very) conservative VADs (like the existing VADs: AMR-NB VAD1/VAD2, AMR-WB-VAD). Using a conservative VAD will increase the likelihood of a good noise prototype but also increase the Channel Transmission activity. I.e. unnecessary many speech frames are marked with SP=1, creating the transmission of a full speech frame.

Some speech codecs like AMR-NB/WB and EVRC [reference 10] and G.729 Annex B [reference 9] has a non-fixed noise hangover functionality inside the VAD block (noise level dependent, or previous frametype dependent) to guarantee that back-end speech is coded properly, they do however not provide functionality to guarantee that the comfort noise model is good enough to be used for SID/DTX noise coding. G.729B has a method for variable rate SID transmission, determining a new SID transmission based on analysis of the noise signal, but no solution for extending DTX-hangover period.

### SUMMARY

The invention analyses the noise character inside and/or during the DTX-hangover period, and decides if the noise character is stable enough to be used as a comfort noise generation model for the decoder synthesis provided that the transmitting encoder is using an averaging operation and/or that the receiving decoder will use an averaging function during the DTX-hangover time period.

Further if the noise character is deemed to be inappropriate, the DTX-hangover period may be extended. This may occur when the VAD is very aggressive and allows trailing low energy speech into the DTX-hangover period, or when the VAD fails to detect an onset speech frame. Further the time extension of the DTX-hangover may be limited to a maximum number of extension frames, to not have an adverse affect on capacity.

Further if the noise character is deemed appropriate and the encoder and decoder DTX-states are synchronized, the DTX-hangover period may be reduced. (This may occur when the used VAD is very cautious and adds more VAD-noise hangover frames than necessary.)

Further the algorithm is taking into account the actual decoder DTX-CNG (Discontinuous Transmission/Comfort Noise Generator) states, i.e. the algorithm will make sure that it is synchronized with the decoder DTX-buffer analysis algorithm. Thus not adding extra DTX-HO frames when the decoder is not going to use them, or shortening the DTX-HO frames when the decoder requires some addition DTX-HO frames.

### BRIEF DESCRIPTION OF THE DRAWINGS

FIG. 1 shows the main functional building blocks for the encoder side of a prior art VAD/DTX/Codec system.

FIG. 2 shows a prior art hangover procedure from 3GPP/TS26.093v610.

FIG. 3 shows the possible frametype effects of extension and reduction in an updated encoder VAD/DTX/codec-system.

FIG. 4 shows energy values and DTX-handler states during DTX-HO extension according to the invention.

FIG. 5 shows energy values and DTX-handler states during DTX-HO reduction according to the invention.

FIG. 6 shows the effect of HO extension used together with aggressive VAD.

### DESCRIPTION OF PREFERRED EMBODIMENTS

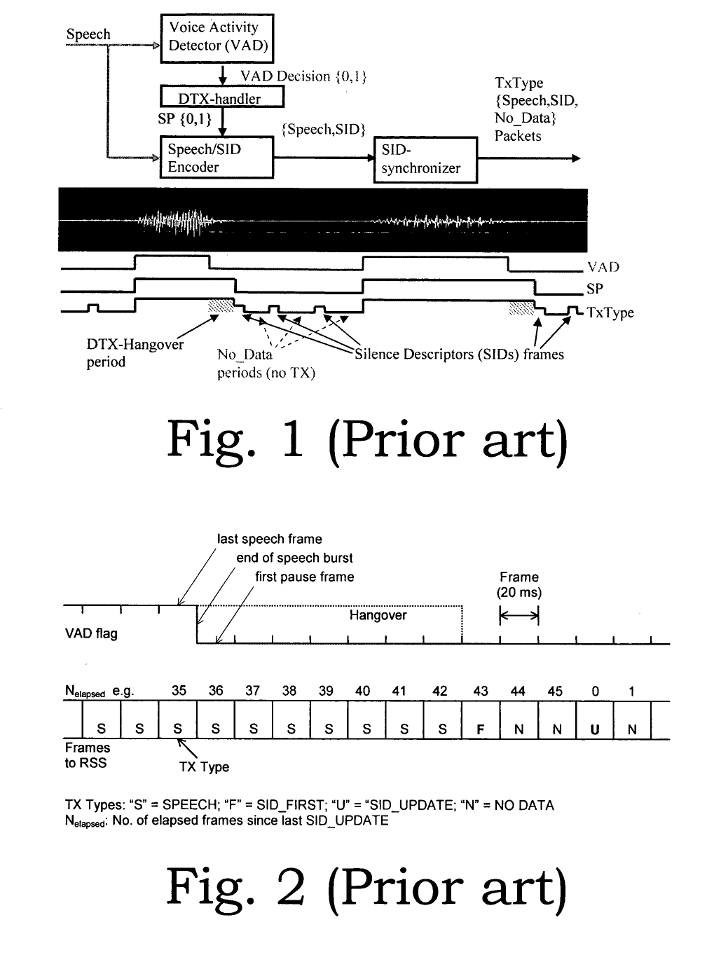

FIG. 1 shows the main functional building blocks for the encoder side of a prior art VAD/DTX/Codec system. Speech is fed into a VAD and a speech/SID encoder. The VAD forms a decision, wherein “1” is frame containing speech and “0” is frame containing no speech. The VAD decision VAD{0,1} is fed into a DTX-handler. The DTX-handler adds a DTX-hangover period to the VAD decision and a decision SP{0,1} is forwarded to the speech/SID encoder. The speech is encoded for the frames indicated as speech frames SP=1. SID frames are also generated and synchronized and frames TxType is transmitted including Speech frames, SID frames and No_Data frames.

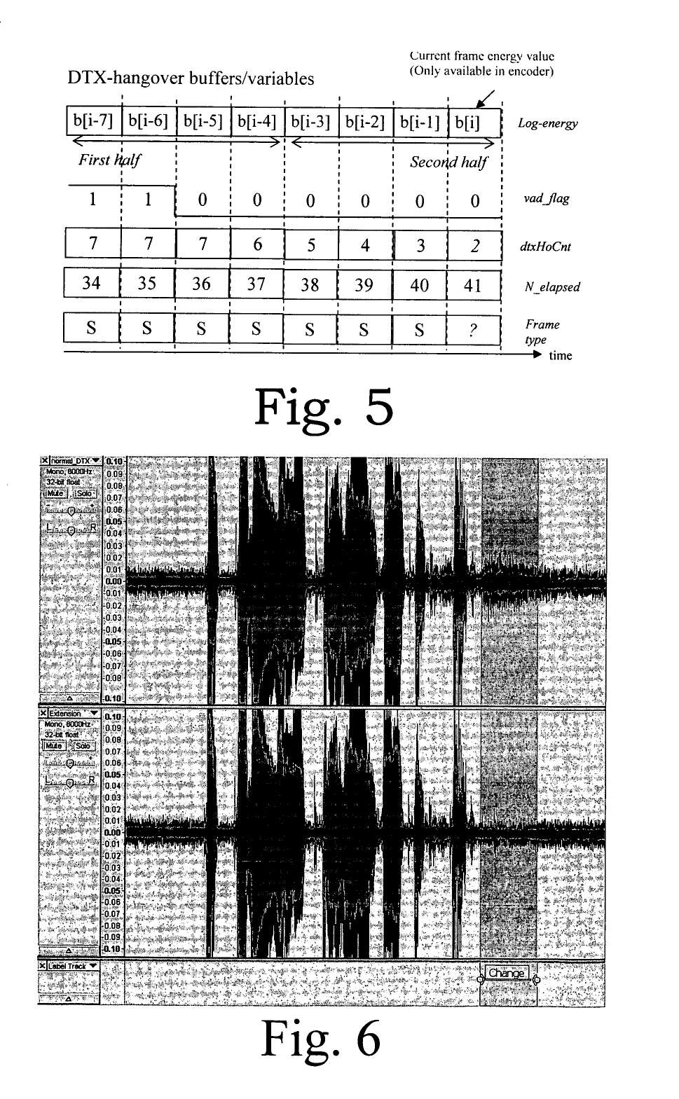

FIG. 2 shows a TX-DTX SCR handler taken from 3GPP/TS26.093v610 “FIG. 6: Normal hangover procedure (N_{elapsed}>23)”. Seven extra frames are added as speech frames after the VAD flag has indicated “end of speech”.

In FIG. 2 the normal operation of the AMR-NB TX-DTX handler in FIG. 1 after longer speech bursts is shown. The invention embodiments will show how one may modify the length of the ‘hangover’=(DTX-HO) time period based on analysis of signals available in the encoder, to preserve quality or increase system efficiency.

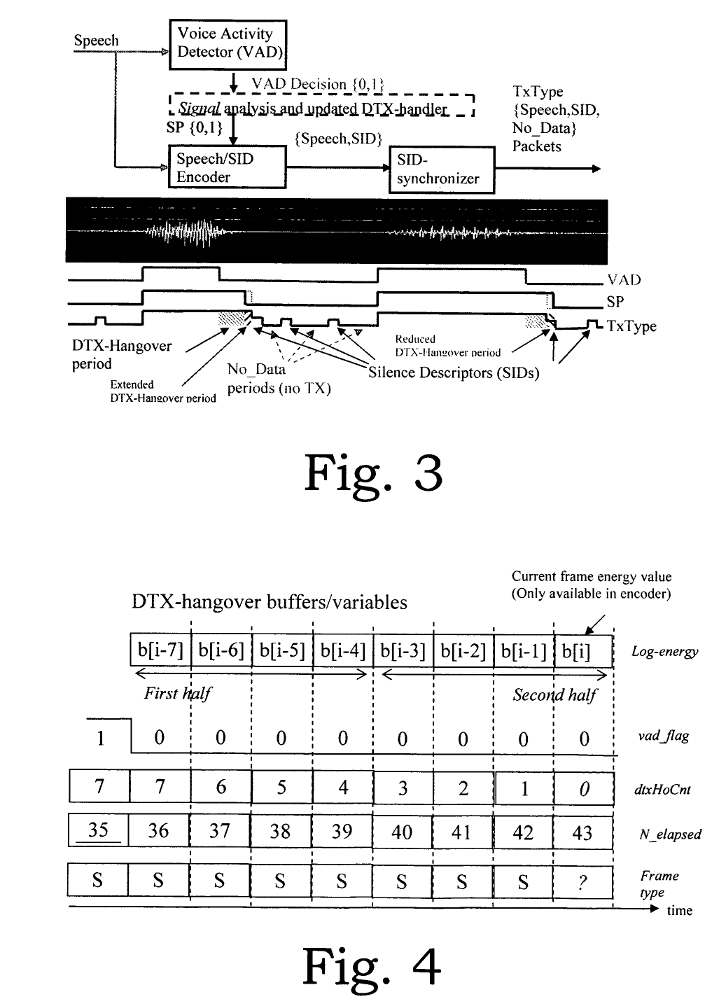

FIG. 3 shows the main functional blocks for the encoder side of an embodiment of a VAD/DTX/codec system according to the invention. The system comprises the same components as the prior art system described in connection with FIG. 1 with one exception. The normal DTX-handler has been replaced by a signal analyzer and an updated DTX handler. The adjustment of the DTX-HO period is performed by the updated DTX handler based on the new information provided by the added signal analyzer.

### DTX Hangover Extension

FIG. 4 shows energy values and DTX-handler states available in the encoder in FIG. 3. In this first embodiment, the extension of the DTX-HO time period is performed using three decision variables, and a weighted decision sum of these three measures are used to determine the need to extend the DTX-HO time period.

### Decision Variables

The decision variables used are based on analysis of the speech frames. In FIG. 4 a notation for the frame energy values readily available for each encoder frame is shown. (E.g. b[i] is the log energy value for the current frame.)

The first decision variable ‘dec_energy_flag’, provides information if there is a significant decrease of assumed noise model energy in the current 8 frame noise quantization period (incl. the DTX-HO period).

$$dec\_energy \_flag = \{ \begin{matrix}1 , & if first\_half \_en > ( \begin{matrix}second\_half \_en + \\ DTX\_PUFF \_THR\end{matrix} ) \\ 0 , & if first\_half \_en \leq ( \begin{matrix}second\_half \_en + \\ DTX\_PUFF \_THR\end{matrix} )\end{matrix}$$

where:
first_half_en is the energy in the four oldest DTX-HO frames,
second_half_en is the energy in the four newest frames and
DTX_PUFF_THR is a constant value.

The second decision variable ‘var_energy_flag’ provides information if there is a significant change in noise energy variation from the previous pre-speech noise-only segment.

$$var\_energy \_flag = \{ \begin{matrix}1 , & if dtxMaxMinDiff > ( \begin{matrix}dtxLastMinMaxDiff + \\ DTX\_MAXMIN \_THR\end{matrix} ) \\ 0 , & if dtxMaxMinDiff \leq ( \begin{matrix}dtxLastMinMaxDiff + \\ DTX\_MAXMIN \_THR\end{matrix} )\end{matrix}$$

where:
dtxMaxMinDiff=max(b[i−7], . . . , b[i])−min (b[i−7], . . . , b[i]),
dtxLastMinMaxDiff is the same measure as dtxMaxMinDiff but updated when (vad_flag=0 and dtxHoCnt=0). (The last period of noise prior to the current speech segment), and
DTX_MAXMIN_THR is a constant value.

The third decision variable higher_energy_flag provides information if there has been a significant change in noise energy since the previous pre-speech noise-only segment.

$$higher\_energy \_flag = \{ \begin{matrix}1 , & if dtxAvgLogEn > ( \begin{matrix}dtxLastAvgLogEn + \\ higher\_energy \_thr\end{matrix} ) \\ 0 , & if dtxAvgLogEn \leq ( \begin{matrix}dtxLastAvgLogEn + \\ higher\_energy \_thr\end{matrix} )\end{matrix} \\ where \text{:} \\ dtxAvgLogEn = ( {\sum }_{k = 0}^{7} \frac{b [ i - k ]}{8} ) - max ( b [ i - 7 ] , … , b [ i ] ) + min ( b [ i - 7 ] , … , b [ i ] )$$

dtxLastAvgLogEn is the same measure as dtxAvgLogEn but updated when (Vad_flag=0 and dtxHoCnt=0). (The last period of noise prior to the current speech segment), and
higher_energy_thr is a time dependent thresholding variable defined by:
higher_energy_thr=dtxLastMinMaxDiff/2+16*dbcHoExtCnt
where
dbcHoExtCnt is the number of additional DTX-HO extension frames, reset when DTX-HO is exited

The final decision to add an additional DTX-HO frame is performed using a weighted decision metric which results in the boolean DTX_NOISEBURST_WARNING.

$$DTX\_NOISEBURST \_WARNING = \{ \begin{matrix}1 , & if dec\_energy \_flag + var\_energy \_flag + 2 * higher\_energy \_flag \geq 2 \\ 0 , & if dec\_energy \_flag + var\_energy \_flag + 2 * higher\_energy \_flag < 2\end{matrix}$$

If DTX_NOISEBURST_WARNING is “1” an extra DTX hangover frame is added to the DTX-HO period, i.e. it is sufficient to have higher energy to add an extra DTX hangover frame.

Furthermore, the final DTX_NOISEBURST_WARNING decision can be inhibited by setting a maximum number of allowed extension frames (DTX_MAX_HO_EXT_CNT).

$$final DTX\_NOISEBURST \_WARNING = \{ \begin{matrix}1 , & \begin{matrix}if DTX\_NOISEBURST \_WARNING = {}_{}^{``}{1}{}_{}^{″} and \\ dtxHoExtCnt < DTX\_MAX \_HO \_EXT \_CNT\end{matrix} \\ 0 , & otherwise\end{matrix}$$

If final DTX_NOISEBURST_WARNING is “1” (true), the transition from speech frame to non-speech frame is delayed by one frame. This can be achieved by setting the DTX-handler state variable dtxHoCnt to a value other than zero, this will give the result that the encoder prepares a quantized Speech (‘S’) frame.

Appendix 1-3 is an actual AMR-NB fixed point C-code performing embodiment 1.

### Appendix 1

cod_amr.c the part of the code controlling the encoding of each frame

### Appendix 2

dtx_enc.c the part of the code containing the encoder side of the DTX_handler

### Appendix 3

dtx_enc.h Definitions of the parameters, data types and function prototypes for the encoder side DTX_handler.

The relevant functions in the c-code are: dtx_noise_puff warning and tx_dtx_handler both defined in dtx_enc.c and called from cod_amr.c.

Instead of only using the low complexity energy measures as described above, one may also use the spectral parameters, LSPs or LSFs to determine the spectral stationarity of the signal in the DTX-HO time period, as is described below in a second embodiment for extending the DTX-HO period. With respect to the frames inside the DTX-HO time period and a previous pre-speech noise-only segment. E.g. The LSPs average from the DTX-HO period may not differ by more than a constant from the LSP-average obtained from the previous pre-speech noise-only period.

$$LSP\_change \_flag = \{ \begin{matrix}1 & if {\sum }_{i = 0}^{9} \vert \begin{matrix}dtxAvgLSP ( i ) - \\ dtxLastAvgLSP ( i )\end{matrix} \vert > LSP\_CHANGE \_THR \\ 0 & if {\sum }_{i = 0}^{9} \vert \begin{matrix}dtxAvgLSP ( i ) - \\ dtxLastAvgLSP ( i )\end{matrix} \vert \leq LSP\_CHANGE \_THR\end{matrix}$$

### Wherein

dtxAvgLSP is the LSP average vector for the current DTX-HO time period,
and dtxLastAvgLSP is also an LSP average vector but updated when (vad_flag=0 and dtxHoCnt=0). (The last period of noise prior to the current speech segment), and
LSP_CHANGE_THR is a constant.

The Boolean decision variable LSP_change_flag may be used in the sum of the DTX_NOISEBURST_WARNING, e.g.

$$DTX\_NOISEBURST \_WARNING = \{ \begin{matrix}1 , & \begin{matrix}if LSP\_change \_flag + dec\_energy \_flag + \\ var\_energy \_flag + 2 * higher\_energy \_flag \geq 2\end{matrix} \\ 0 , & \begin{matrix}if LSP\_change \_flag + dec\_energy \_flag + \\ var\_energy \_flag + 2 * higher\_energy \_flag < 2\end{matrix}\end{matrix}$$

### DTX Hangover Reduction

In this first embodiment of the reduction of the DTX-HO time period is performed using three decision variables, and a weighted decision sum of these three measures are used to determine the possibility to reduce the DTX-HO time period. In addition the DTX-handler state variables are examined to determine that the decoder will be in synch and actually use the now reduced DTX-HO period.

### Decision Variables

The decision variables used are based on analysis of the speech frames. In FIG. 5, a notation for the frame energy values and DTX-handler states readily available for each encoder frame is shown. (E.g. b[i] is the log energy value for the current frame.)

Example algorithm for DTX-HO reduction:
If dtxHoCnt is less than 3 and
if N_elapsed is high enough so that DTX-hangover is actually active and
if all the decision variables (dec_energy_flag, var_energy_flag, higher_energy_flag) (defined in embodiment 1) are all zero (the sum is zero)
   then, the decision is taken to reduce the DTX-hangover period. (The actual reduction may be achieved by forcing the dtxHoCnt variable to zero, prior to calling the encoder dtx-handler, this will result in a low rate SID-frame type (F/SID_FIRST in the AMR case) being prepared for transmission, instead of the higher rate Speech frame type.

Otherwise the hangover period is continued as normal (with optional hangover extension if desired).

As in the hangover extension case the spectrum parameters may also be considered. E.g. to active the reduction one can require that the previously defined decision variable LSP_change_flag is zero.

EFR/AMR-NB/AMR-WB CNG (Comfort Noise Generator) may be used in combination with an aggressive and capacity effective VAD which occasionally makes suboptimal VAD-decisions, without any quality decrease with respect to the resulting comfort noise synthesis. (Even for use with unmodified already deployed decoders.)

This quality/efficiency update is backward compatible with deployed AMR-NB/EFR decoders. FIG. 6 shows the effect of the hangover extension when the used together with an aggressive VAD in an AMR-NB codec simulation. The top part is the decoder output when using the current averaging only DTX-hangover scheme without extension, and the bottom part is the decoder output when using the described hangover extension scheme. As can be identified the updated scheme provides a better noise energy envelope than the original scheme.

In combination with an existing quite conservative VAD (e.g. AMR-VAD 1 or AMR-VAD2) the DTX-hangover reduction may be used to increase DTX-system efficiency, and occasionally also to increase Comfort Noise quality. The speech encoder, as described above in connection with FIG. 3, may be implemented in a transmitter in a node, such as a user terminal and/or a base station, in a wireless telecommunication system. A corresponding receiver in a receiving node (user terminal or base station) does not need to be modified in order to decode the information encoded by the speech encoder according to the invention in the transmitter when communicating on a communication link. Thus, it is not necessary to include the inventive speech encoder in all nodes present in the telecommunication system since the type of information included in the transmitted signal, as describe in connection with FIGS. 1 and 3, is not altered, but the information content may be adjusted, i.e. the DTX hangover period may be changed.

### Abbreviations

AMR Adaptive Multi-Rate
CAF Channel Activity Factor (System efficiency including speech-frames, DTX-HO speech frames, SID-frames), when the sender is transmitting energy.
CN Comfort Noise
CNG Comfort Noise Generator
DTX Discontinuous Transmission
DTX-HO DTX-HangOver time period
EFR Enhanced Full Rate
EVRC Enhanced Variable Rate Codec
LSF Line Spectral Frequency
LSP Line Spectral Pair
N,ND “NoData” frame type
NB Narrow Band
SID SIlence Descriptor (actually Noise Descriptor)
SF,F “SID_FIRST” AMR(NB/WB) SID frame type
SP,S “Speech” frame type
U,SU “SID_UPDATE” AMR(NB/WB) SID frame type
VAD Voice Activity Detector
VAD-HO VAD-hangover (VAD internal safety time period for transitions from speech to noise) a.k.a. “noise-hangover”
VAF Voice Activity Factor (VAD efficiency, excl. SID-frames, excl DTX-HO frames)
WB Wide Band

### REFERENCES

[1] AMR-NB DTX TS 26.093
[2] AMR-WB DTX TS 26.193
[3] AMR-WB CN 26.192
[4] AMR-NB CN 26.092
[5] U.S. Pat. No. 5,835,889 “Method and apparatus for detecting hangover periods in a TDMA wireless communication system using discontinuous transmission”. Kapanen.
[6] EP0843301B1, “Methods for generating comfort noise during discontinuous transmission”, Järvinen.
[7] U.S. Pat. No. 5,410,632, “Variable Hangover time in a voice activity detector”, Hong
[8] U.S. Pat. No. 5,978,761, “Comfort Noise in Decoder”, Johansson, (PDC)
[9] G.729, Annex B (“VAD/DTX”), ITU-T Specification, Includes an adaptive SID-scheduler. ITU-T Recommendation G.727: Annex B: A silence compression scheme for G.729 otimized for terminals conforming to Recommendation V.70
[10] EVRC-A (3GPP2/C.S0014-A_v1.0, 20040426), and EVRC-B (3GPP2/C.S0014-B_v1.0_{—}060501) EVRC-A VAD includes adaptive noise hangover and EVRC-B includes a fixed DTX-hangover

What is claimed is:

1-17. (canceled)

18. A method for estimating the characteristic of a discontinuous transmission (DTX) hangover period in a speech encoder, comprising the steps of:
analyzing frame energy values of speech frames within the DTX-hangover period; and
adjusting the length of the DTX-hangover period in response to the frame energy analysis.

19. The method according to claim 18, wherein the step of analyzing the energy value of the speech frames includes analyzing any of energy decrease, energy variation, and long term energy increase.

20. The method according to claim 18, wherein the method further comprises the steps of:
analyzing spectral parameters of the speech frames in the DTX-hangover period; and
taking the response from the spectral parameter analysis into account when the length of the DTX-hangover period is adjusted.

21. The method according to claim 20, wherein the step of analyzing the spectral parameters of the speech frames includes analyzing any of spectral variations and long term spectral differences.

22. The method according to claim 18, wherein the DTX-hangover period is extended when the speech frames within the DTX-hangover period are deemed inappropriate for noise generation.

23. The method according to claim 18, wherein the DTX-hangover period is reduced when the speech frames within the DTX-hangover period are deemed appropriate for noise generation.

24. A speech encoder, comprising:
a voice activity detector (VAD) configured to receive speech frames and to generate a speech decision (VAD_flag);
a speech/silence descriptor (SID) encoder configured to receive said speech frames and to generate a signal identifying speech frames based on the encoder decision (SP), which in turn is based on the speech decision (VAD_flag) and a discontinuous transmission (DTX) hangover period; and
an SID-synchronizer configured to transmit a signal (TxType) comprising speech frames, SID frames and No_data frames;
the speech/SID encoder further comprising a signal analyzer configured to analyze energy values of speech frames within the DTX-hangover period, and a DTX-handler configured to adjust the length of the DTX-hangover period in response to the analysis performed by the signal analyzer.

25. The speech encoder according to claim 24, wherein the signal analyzer is configured to analyze any of energy decrease, energy variation, and long term energy increase.

26. The speech encoder according to claim 24, wherein the signal analyzer is configured to analyze spectral parameters of the speech frames in the DTX-hangover period, and the DTX-handler is configured to take the response from the spectral parameter analysis into account when the length of the DTX-hangover period is adjusted.

27. The speech encoder according to claim 26, wherein the signal analyzer further is configured to analyze spectral variations, and long term spectral differences of the speech frames.

28. The speech encoder according to claim 24, wherein the DTX-handler is configured to extend the DTX-hangover period when the speech frames within the DTX-hangover period are deemed inappropriate for noise generation.

29. The speech encoder according to claim 24, wherein the DTX-handler is configured to reduce the DTX-hangover period when the speech frames within the DTX-hangover period are deemed appropriate for noise generation.

30. A transmitter configured to transmit signals in a wireless telecommunication system, said transmitter comprising a speech encoder as defined in claim 24.

31. A node in a wireless telecommunication system comprising a speech encoder as defined in claim 24.

32. The node according to claim 31, wherein the node is a user terminal.

33. The node according to claim 31, wherein the node is a base station.

34. A wireless telecommunication system comprising at least one node as defined in claim 31.
